(19) United States
(12) Patent Application Publication
(10) Pub. No.: US 2024/0248175 A1
(43) Pub. Date: Jul. 25, 2024

(54) EXTERNAL ENVIRONMENT RECOGNITION APPARATUS

(71) Applicant: Honda Motor Co., Ltd., Tokyo (JP)

(72) Inventors: Shunsuke Konishi, Wako-shi (JP); Ryota Okutsu, Tokyo (JP); Hidetoshi Utsumi, Wako-shi (JP)

(21) Appl. No.: 18/401,552

(22) Filed: Dec. 31, 2023

(30) Foreign Application Priority Data
Jan. 19, 2023 (JP) 2023-006463

(51) Int. Cl. G01S 7/48; G01S 17/42; G01S 17/89; G01S 17/931

(52) U.S. Cl. CPC G01S 7/4802; G01S 17/42; G01S 17/89; G01S 17/931

(57) ABSTRACT

An external environment recognition apparatus including: an in-vehicle detector configured to scan and emit an electromagnetic wave in a first direction and as a second direction to detect an external environment situation around a subject vehicle; and a microprocessor configured to acquire road surface information based on a detection data of the in-vehicle detector. The in-vehicle detector acquires a three-dimensional point cloud data frame by frame, and the microprocessor is configured to perform: recognizing a surface of the road and a three-dimensional object on the road for each frame as the road surface information based on the three-dimensional point cloud data, and determining an interval of detection points of the three-dimensional point cloud data of a next frame as a scanning angular resolution of the electromagnetic wave based on a size of a predetermined object and a distance from the subject vehicle to the object.

### CROSS-REFERENCE TO RELATED APPLICATION

This application is based upon and claims the benefit of priority from Japanese Patent Application No. 2023-006463 filed on Jan. 19, 2023, the content of which is incorporated herein by reference.

### BACKGROUND OF THE INVENTION

### Field of the Invention

The present invention relates to an external environment recognition apparatus that recognizes an external environment situation around a vehicle.

### Description of the Related Art

As a device of this type, there is known a device for changing emission angles of laser light emitted from a LiDAR about a first axis parallel to a height direction and a second axis parallel to a horizontal direction, performing scanning, and detecting an external environment of a vehicle on the basis of position information of each detection point (for example, see JP 2020-149079 A).

In the above device, many detection points are acquired by scanning, and a processing load for acquiring the position information based on each detection point is large.

### SUMMARY OF THE INVENTION

An aspect of the present invention is an external environment recognition apparatus including: an in-vehicle detector configured to scan and emit an electromagnetic wave in a first direction and as a second direction intersecting the first direction to detect an external environment situation around a subject vehicle; a microprocessor configured to acquire road surface information of a road on which the subject vehicle travels based on a detection data of the in-vehicle detector; and a memory coupled to the microprocessor. The in-vehicle detector acquires a three-dimensional point cloud data including distance information for each of a plurality of detection pointes in a matrix form frame by frame, and the microprocessor is configured to perform: recognizing a surface of the road and a three-dimensional object on the road for each frame as the road surface information based on the three-dimensional point cloud data, and determining an interval of detection points of the three-dimensional point cloud data of a next frame used for recognition in the recognizing as a scanning angular resolution of the electromagnetic wave based on a size of a predetermined three-dimensional object determined in advance as a recognition target and a distance from the subject vehicle to the predetermined three-dimensional object.

### BRIEF DESCRIPTION OF THE DRAWINGS

The objects, features, and advantages of the present invention will become clearer from the following description of embodiments in relation to the attached drawings, in which:

FIG. 1A is a diagram illustrating how a vehicle travels on a road;

FIG. 1B is a schematic diagram illustrating an example of detection data obtained by a LiDAR;

FIG. 2 is a block diagram illustrating a configuration of a main part of a vehicle control device;

FIG. 3A is a diagram illustrating a position of point cloud data in a three-dimensional space using a three-dimensional coordinate system;

FIG. 3B is a diagram describing mapping of the point cloud data from the three-dimensional space to a two-dimensional X-Z space;

FIG. 3C is a schematic diagram illustrating the point cloud data divided for each grid;

FIG. 3D is a schematic diagram illustrating a road surface gradient in depth distance direction;

FIG. 4A is a schematic diagram illustrating a light projection angle and a depth distance;

FIG. 4B is a schematic diagram illustrating a distance measured by the LiDAR;

FIG. 5A is a schematic diagram illustrating an example of a relationship between the depth distance and the light projection angle in a vertical direction;

FIG. 5B is a schematic diagram illustrating an example of a relationship between the depth distance and an angular resolution in the vertical direction;

FIG. 6A is a schematic diagram illustrating an example of an irradiation point when the irradiation light of the LiDAR is emitted in a raster scanning method;

FIG. 6B is a schematic diagram illustrating an example of irradiation points in a case where the irradiation light of the LiDAR 5 is emitted only to predetermined lattice points arranged in a lattice pattern in a detection area;

FIG. 7 is a diagram illustrating an example of an irradiation order in a case where the irradiation points illustrated in FIG. 6Bare irradiated with the irradiation light;

FIG. 8 is a diagram illustrating an example of a result of prediction of the road surface gradient;

FIG. 9 is a flowchart illustrating an example of processing executed by a CPU of the controller in FIG. 2; and

FIG. 10 is a flowchart for describing details of the processing of step S20 in FIG. 9.

### DETAILED DESCRIPTION OF THE INVENTION

Hereinafter, an embodiment of the invention will be described with reference to the drawings.

An external environment recognition device according to an embodiment of the invention is applicable to a vehicle having a self-driving capability, that is, a self-driving vehicle. Note that a vehicle to which the external environment recognition device according to the present embodiment is applied may be referred to as a subject vehicle to be distinguished from other vehicles. The subject vehicle may be any of an engine vehicle including an internal combustion engine (engine) as a traveling drive source, an electric vehicle including a traveling motor as the traveling drive source, and a hybrid vehicle including an engine and a traveling motor as the traveling drive sources. The subject vehicle is capable of traveling not only in a self-drive mode that does not necessitate the driver's driving operation but also in a manual drive mode of the driver's driving operation.

While traveling in the self-drive mode (hereinafter, referred to as self-traveling or autonomous traveling), the self-driving vehicle recognizes an external environment situation in the periphery of the subject vehicle on the basis of detection data of an in-vehicle detector such as a camera or a light detection and ranging (LiDAR). The self-driving vehicle generates a traveling path (a target path) after a predetermined time from the current time point on the basis of recognition results, and controls an actuator for traveling so that the subject vehicle travels along the target path.

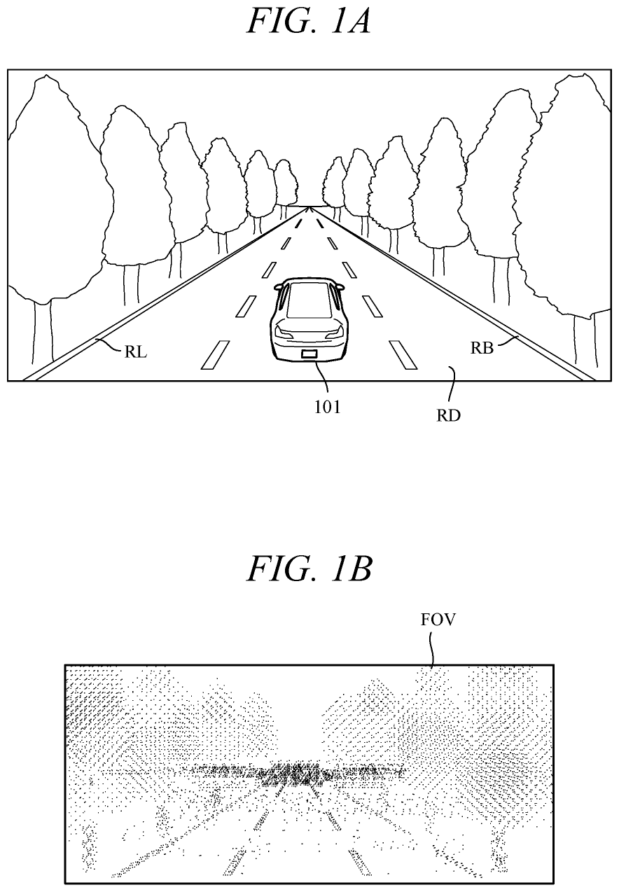

FIG. 1A is a diagram illustrating how a subject vehicle 101, which is a self-driving vehicle, travels on a road RD. FIG. 1B is a schematic diagram illustrating an example of detection data obtained by a LiDAR mounted on the subject vehicle 101 and directed in the traveling direction of the subject vehicle 101. The measurement point (which may also be referred to as a detection point) by the LiDAR is point information of the emitted laser that has been reflected by a certain point on a surface of an object and then returned. The point information includes the distance from the laser source to the point on which the emitted laser has been reflected, the intensity of the laser reflected and returned, and the relative velocity between the laser source and the point. In addition, data including a plurality of detection points as illustrated in FIG. 1B will be referred to as point cloud data. FIG. 1B illustrates point cloud data based on detection points of surfaces of objects included in the field of view (hereinafter referred to as FOV) of the LiDAR among the objects in FIG. 1A. The FOV may be, for example, 120 deg in a horizontal direction (which may be referred to as a road width direction) and 40 deg in a vertical direction (which may be referred to as an up-down direction) of the subject vehicle 101. The value of the FOV may be appropriately changed on the basis of the specifications of the external environment recognition device. The subject vehicle 101 recognizes an external environment situation in the periphery of the vehicle, more specifically, a road structure, an object, and the like in the periphery of the vehicle on the basis of the point cloud data as illustrated in FIG. 1B, and generates a target path on the basis of the recognition results.

As a method for sufficiently recognizing the external environment situation in the periphery of the vehicle, by the way, it is conceivable to increase the number of irradiation points of electromagnetic waves emitted from the in-vehicle detector such as a LiDAR (in other words, to increase irradiation point density of electromagnetic waves so as to increase the number of detection points constituting the point cloud data). On the other hand, in a case where the number of irradiation points of electromagnetic waves is increased (the number of detection points is increased), there is a possibility that a processing load for controlling the in-vehicle detector increases, a capacity of the detection data (the point cloud data) obtained by the in-vehicle detector increases, and a processing load for the point cloud increases. In particular, in a situation where there are many objects on the road or beside the road, the capacity of the point cloud data further increases.

Hence, in consideration of the above points, in the embodiment, the external environment recognition device is configured as described below.

### <Overview>

The external environment recognition device according to the embodiment intermittently emits irradiation light as an example of electromagnetic waves in the traveling direction of the subject vehicle 101 from the LiDAR of the subject vehicle 101, which travels on the road RD, and acquires point cloud data at different positions on the road RD in a discrete manner. The irradiation range of the irradiation light emitted from the LiDAR is set such that a blank section of data does not occur in the traveling direction of the road RD in the point cloud data of a previous frame acquired by the LiDAR by the previous irradiation and the point cloud data of a next frame acquired by the LiDAR by the current irradiation.

By setting the detection point density in the irradiation range to be higher for the road surface far from the subject vehicle 101 and lower for the road surface close to the subject vehicle 101, for example, the total number of detection points used for the recognition processing is suppressed as compared with the case where the high detection point density is set for all the road surfaces in the irradiation range. Thus, it becomes possible to reduce the number of the detection points used for recognition processing without deteriorating the recognition accuracy of the position (the distance from the subject vehicle 101) or the size of an object or the like to be recognized on the basis of the point cloud data.

Such an external environment recognition device will be described in more detail.

### <Configuration of Vehicle Control Device>

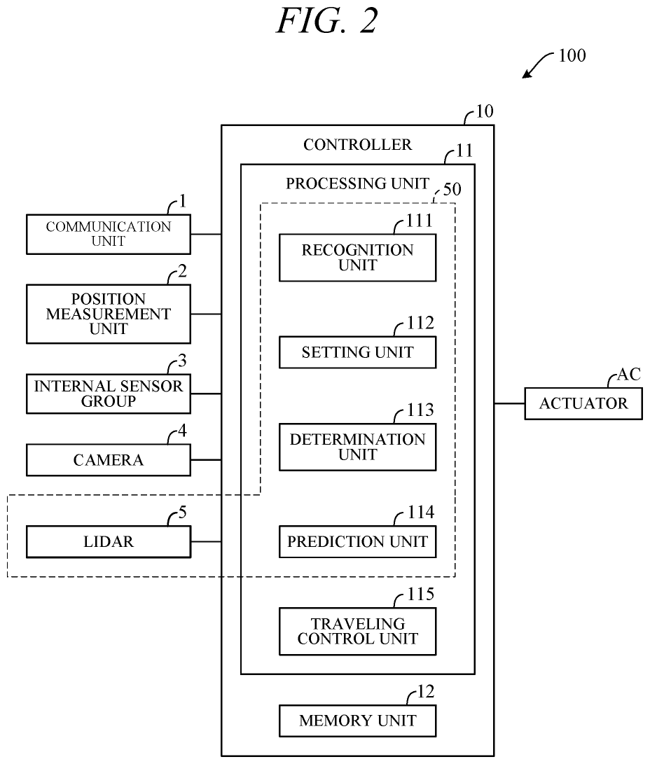

FIG. 2 is a block diagram illustrating a configuration of a main part of a vehicle control device 100 including the external environment recognition device. The vehicle control device 100 includes a controller 10, a communication unit 1, a position measurement unit 2, an internal sensor group 3, a camera 4, a LiDAR 5, and an actuator AC for traveling. In addition, the vehicle control device 100 includes an external environment recognition device 50 constituting a part of the vehicle control device 100. The external environment recognition device 50 recognizes an external environment situation in the periphery of the vehicle on the basis of detection data of an in-vehicle detector such as the camera 4 or the LiDAR 5.

The communication unit 1 communicates with various servers, which are not illustrated, through a network including a wireless communication network represented by the Internet network, a mobile telephone network, or the like, and acquires map information, traveling history information, traffic information, and the like from the servers periodically or at a given timing. The network includes not only a public wireless communication network but also a closed communication network provided for every predetermined management area, for example, a wireless LAN, Wi-Fi (registered trademark), Bluetooth (registered trademark), and the like. The acquired map information is output to a storage unit 12, and the map information is updated. The position measurement unit (GNSS unit) 2 includes a position measurement sensor for receiving a position measurement signal transmitted from a position measurement satellite. The position measurement satellite is an artificial satellite such as a GPS satellite or a quasi-zenith satellite. By using the position measurement information that has been received by the position measurement sensor, the position measurement unit 2 measures a current position (latitude, longitude, and altitude) of the subject vehicle 101.

The internal sensor group 3 is a general term of a plurality of sensors (internal sensors) for detecting a traveling state of the subject vehicle 101. For example, the internal sensor group 3 includes a vehicle speed sensor that detects the vehicle speed (traveling speed) of the subject vehicle 101, an acceleration sensor that detects the acceleration in a front-rear direction and the acceleration (lateral acceleration) in a left-right direction of the subject vehicle 101, a rotation rate sensor that detects the rotation rate of the traveling drive source, a yaw rate sensor that detects the rotation angular speed about the vertical axis of the center of gravity of the subject vehicle 101, and the like. The internal sensor group 3 also includes sensors that detect a driver's driving operation in the manual drive mode, for example, an operation on an accelerator pedal, an operation on a brake pedal, an operation on a steering wheel, and the like.

The camera 4 includes an imaging element such as a CCD or a CMOS, and captures an image of the periphery of the subject vehicle 101 (front side, rear side, and lateral sides). The LiDAR 5 receives scattered light with respect to the irradiation light, and measures a distance from the subject vehicle 101 to an object in the periphery, a position and shape of the object, and the like.

The actuator AC is an actuator for traveling in order to control traveling of the subject vehicle 101. In a case where the traveling drive source is an engine, the actuator AC includes an actuator for throttle to adjust an opening (a throttle opening) of a throttle valve of the engine. In a case where the traveling drive source is a traveling motor, the traveling motor is included in the actuator AC. The actuator AC also includes an actuator for braking that actuates a braking device of the subject vehicle 101, and an actuator for steering that drives a steering device.

The controller 10 includes an electronic control unit (ECU). More specifically, the controller 10 is configured to include a computer including a processing unit 11 such as a CPU (microprocessor), the storage unit 12 such as ROM and RAM, and other peripheral circuits, which are not illustrated, such as an I/O interface. Note that a plurality of ECUs having different functions such as an ECU for engine control, an ECU for traveling motor control, and an ECU for braking device can be individually provided. However, in FIG. 2, the controller 10 is illustrated as an aggregation of these ECUs for the sake of convenience.

The storage unit 12 can store highly precise detailed map information (referred to as high-precision map information). The high-precision map information includes position information of roads, information of road shapes (curvature or the like), information of road gradients, position information of intersections or branch points, information of the number of traffic lanes (traveling lanes), information of traffic lane widths and position information for every traffic lane (information of center positions of traffic lanes or boundary lines of traffic lane positions), position information of landmarks (traffic lights, traffic signs, buildings, and the like) as marks on a map, and information of road surface profiles such as irregularities of road surfaces. In addition to two-dimensional map information to be described below, the storage unit 12 can also store programs for various types of control, information of thresholds for use in programs, or the like, and setting information (irradiation point information to be described below, and the like) for the in-vehicle detector such as the LiDAR 5.

Note that, since the embodiment does not necessarily require highly precise detailed map information, the detailed map information may not be stored in the storage unit 12.

The processing unit 11 includes a recognition unit 111, a setting unit 112, a determination unit 113, a prediction unit 114, and a traveling control unit 115, as functional configurations. Note that, as illustrated in FIG. 2, the recognition unit 111, the setting unit 112, the determination unit 113, and the prediction unit 114 are included in the external environment recognition device 50. As described above, the external environment recognition device 50 recognizes an external environment situation in the periphery of the vehicle on the basis of the detection data of the in-vehicle detector such as the camera 4 or the LiDAR 5. Details of the recognition unit 111, the setting unit 112, the determination unit 113, and the prediction unit 114 included in the external environment recognition device 50 will be described below.

In the self-drive mode, the traveling control unit 115 generates a target path on the basis of the external environment situation in the periphery of the vehicle that has been recognized by the external environment recognition device 50, and controls the actuator AC so that the subject vehicle 101 travels along the target path. Note that in the manual drive mode, the traveling control unit 115 controls the actuator AC in accordance with a traveling command (steering operation or the like) from the driver that has been acquired by the internal sensor group 3.

The LiDAR 5 will be further described.

### <Detection Area>

The LiDAR 5 is attached to face the front side of the subject vehicle 101 so that the FOV includes an area to be observed during traveling. Since the LiDAR 5 receives the light irradiated with the irradiation light and scattered by a three-dimensional object or the like, the FOV of the LiDAR 5 corresponds to the irradiation range of the irradiation light and the detection area. That is, the irradiation point in the irradiation range corresponds to the detection point in the detection area.

In the embodiment, a road surface shape including irregularities, steps, undulations, or the like of a road surface, a three-dimensional object located on the road RD (equipment related to the road RD (a traffic light, a traffic sign, a groove, a wall, a fence, a guardrail, and the like)), an object on the road RD (including other vehicles and an obstacle on the road surface), and a division line provided on the road surface will be referred to as a three-dimensional object or the like. The division line includes a white line (including a line of a different color such as yellow), a curbstone line, a road stud, and the like, and may be referred to as a lane mark. In addition, a three-dimensional object or the like that has been set beforehand as a detection target will be referred to as a detection target.

### <Example of Coordinate System>

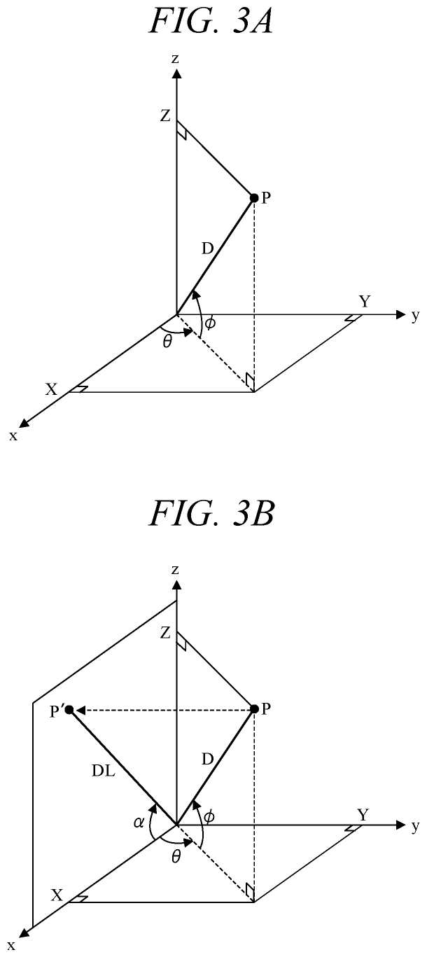

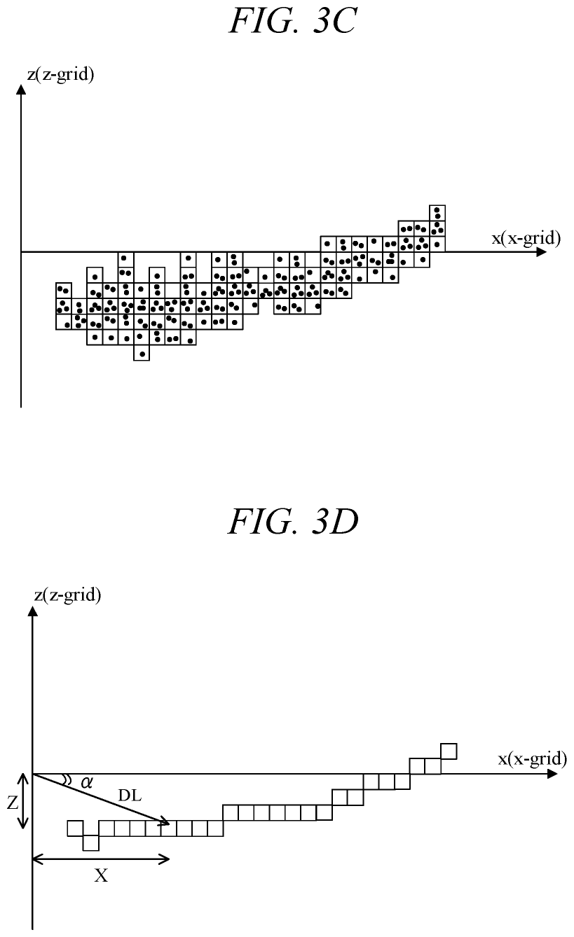

FIG. 3A is a diagram illustrating a position of point cloud data in a three-dimensional space using a three-dimensional coordinate system. In FIG. 3A, an x-axis plus direction corresponds to a traveling direction of the subject vehicle 101, a y-axis plus direction corresponds to a left side of the subject vehicle 101 in a horizontal direction, and a z-axis plus direction corresponds to an upper side in a vertical direction.

In addition, an x-axis component of the position of data P is referred to as a depth distance X, a y-axis component of the position of the data P is referred to as a horizontal distance Y, and a z-axis component of the position of the data P is referred to as a height Z.

Assuming that the distance measured by the LiDAR 5, in other words, the distance from the LiDAR 5 to the point on the object as the detection target is D, coordinates (X, Y, Z) indicating the position of the data P are calculated by the formulae described below.

$$X = D \times cos θ \times cos φ \qquad ( 1 )$$

$$Y = D \times sin θ \times cos φ \qquad ( 2 )$$

$$Z = D \times sin φ \qquad ( 3 )$$

Note that the angle θ is referred to as a horizontal light projection angle, and the angle φ is referred to as a vertical light projection angle. The horizontal light projection angle θ and the vertical light projection angle φ are set to the LiDAR 5 by the setting unit 112.

FIG. 3B is a diagram describing mapping of the point cloud data from the three-dimensional space to the two-dimensional X-Z space. In the embodiment, in order to calculate the road surface gradient of the road RD, mapping is performed from the data P in the three-dimensional space to data P′ in the X-Z space for each data constituting the point cloud data. By this mapping, three-dimensional point cloud data is converted into two-dimensional point cloud data in the X-Z space. In the X-Z space, information indicating the horizontal distance Y is omitted, and information of the depth distance X and the height Z remains.

Next, the X-Z space is divided by grids having a predetermined size (for example, 50 cm square), and the number of pieces of data P′ included in each grid is counted. FIG. 3C is a schematic diagram illustrating the point cloud data divided for each grid. Note that the number of grids based on the actual data P′ is much larger than the illustrated number.

FIG. 3C illustrates the position data (depth distance X) for each grid, the height Z for each grid, and the number of pieces of data P′ included in each grid. In the embodiment, since the data of the three-dimensional object is separated and excluded in advance, the data is mainly grid data of X and Z with respect to the data (which may be referred to as road surface data) of the road surface. Therefore, by sequentially extracting the grid in which the number of pieces of data P′ in the grid is maximized in the depth distance X direction, a row of grids indicating the height Z of the road surface as illustrated in FIG. 3D, that is, the road surface gradient in the depth distance X direction can be obtained.

When attention is paid to each grid, Formula (4) described below is established between light projection angle α in the vertical direction with respect to the road surface point (corresponding to the irradiation point described above) of the grid, the depth distance X of the road surface point, and the height Z of the road surface. In addition, Formula (5) described below is established between a distance DL from the LiDAR 5 to the road surface point, the depth distance X of the road surface point, and the height Z of the road surface.

$$tan α = Z / X \qquad ( 4 )$$

$$DL = ( X 2 + Z 2 ) 1 / 2 \qquad ( 5 )$$

### <Light Projection Angle and Depth Distance>

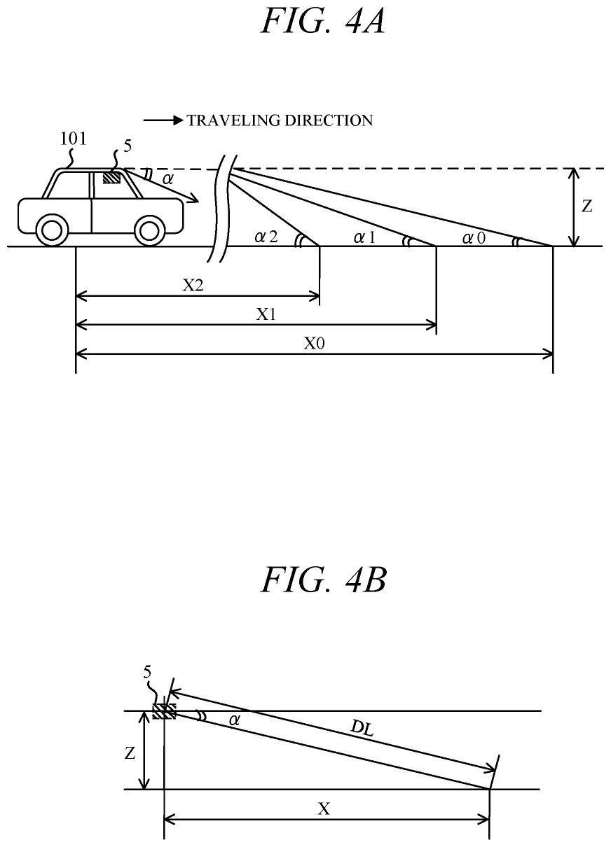

FIG. 4A is a schematic diagram illustrating the light projection angle α in the vertical direction of the LiDAR 5 (angle of irradiation light with respect to the horizontal direction) and the depth distance X. By changing the light projection angle α, the external environment recognition device 50 changes the irradiation direction of the irradiation light upward and downward so as to move the position of the irradiation point in the vertical direction.

In FIG. 4A, in a case where the irradiation light is emitted on the road RD at the location point where a depth distance X2 is 10 m, the road surface is irradiated at an incident angle α2. In addition, in a case where the irradiation light is emitted on the road RD at the location point where a depth distance X1 is 40 m, the road surface is irradiated at an incident angle α1. Further, in a case where the irradiation light is emitted on the road RD at the location point where a depth distance X0 is 100 m, the road surface is irradiated at an incident angle α0.

In general, the larger the incident angle with respect to the road surface, the weaker the scattered light returning from the road surface to the LiDAR 5. Therefore, in many cases, the reception level of the scattered light with respect to the irradiation light to the location point of the depth distance X0 is the lowest.

FIG. 4B is a schematic diagram illustrating the distance DL measured by the LiDAR 5. As described above with reference to FIGS. 3A to 3D, the external environment recognition device 50 calculates the depth distance X to the road surface point irradiated with the irradiation light and the height Z of the road surface point using the light projection angle α set to the LiDAR 5, the distance DL (optical path length of the irradiation light) measured by the LiDAR 5, and Formulas (4) and (5) described above.

The external environment recognition device 50 decreases the light projection angle α in a case where the depth distance is desired to be longer than a current value, and increases the light projection angle α in a case where the depth distance is desired to be shorter than the current value. For example, in a case of changing the depth distance to 100 m from a state in which the irradiation light is emitted on the location point where the depth distance is 70 m, the external environment recognition device 50 makes the light projection angle α smaller than the current value so that the irradiation light is emitted on the location point where the depth distance is 100 m. In addition, for example, in a case where the road RD is a downward gradient or the like and the road RD is not irradiated with the irradiation light, the external environment recognition device 50 makes the light projection angle α larger than the current angle so that the road RD is irradiated with the irradiation light.

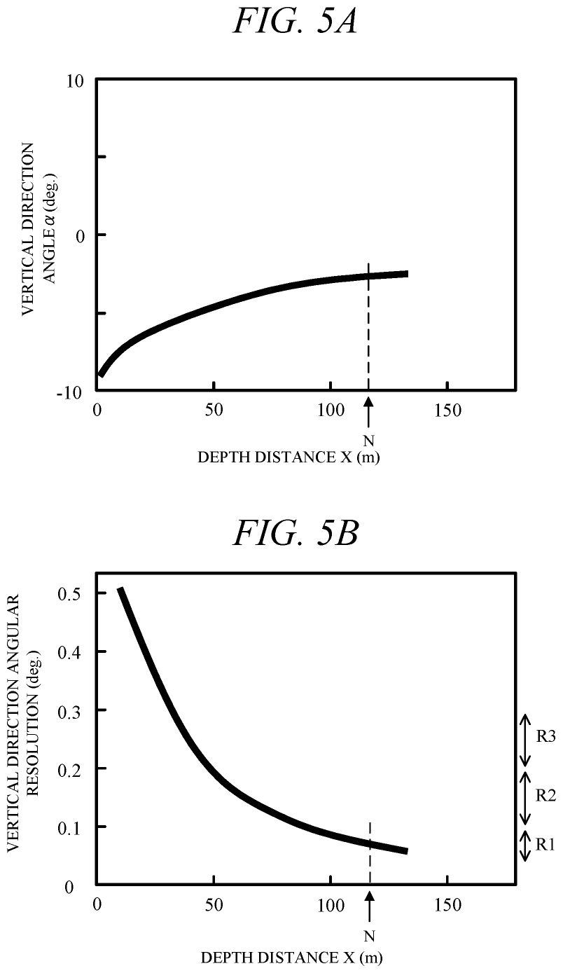

FIG. 5A is a schematic diagram illustrating an example of a relationship between the depth distance X and the light projection angle α in the vertical direction. The horizontal axis indicates the depth distance X (unit: m), and the vertical axis indicates the light projection angle α (unit: deg) in the vertical direction. The light projection angle α may be referred to as a vertical direction angle. As illustrated in FIG. 5A, the external environment recognition device 50 increases the light projection angle α to the minus side when it is desired to shorten the depth distance X, and decreases the light projection angle α when it is desired to lengthen the depth distance X. Reference sign N will be described below.

### <FOV and Depth Distance>

In the embodiment, the road surface situation from the depth distance (for example, X2 in FIG. 4A) corresponding to the lower end of the FOV of the LiDAR 5 to the depth distance (for example, X0 in FIG. 4A) corresponding to the upper end of the FOV is detected. The depth distance corresponding to the lower end of the FOV will be referred to as a first predetermined distance, and the depth distance corresponding to the upper end of the FOV will be referred to as a second predetermined distance.

In general, the camera 4 is superior to the LiDAR 5 in terms of resolution at a short distance, and the LiDAR 5 is superior to the camera 4 in terms of distance measurement accuracy and relative speed measurement accuracy. Therefore, in a case where the angle of view of the camera 4 is wider in the vertical direction than the FOV of the LiDAR 5, the external environment recognition device 50 may cause the camera 4 to detect the road surface situation for the lower side (in other words, a road surface closer to the subject vehicle 101 than the first predetermined distance) of the lower end of the FOV of the LiDAR 5.

### <Number of Irradiation Points of Irradiation Light>

The external environment recognition device 50 calculates the position of an irradiation point to be irradiated with the irradiation light of the LiDAR 5 in the FOV of the LiDAR 5. More specifically, the external environment recognition device 50 calculates an irradiation point in accordance with an angular resolution to be calculated on the basis of a minimum size (for example, 15 cm in both vertical direction and horizontal direction) of the detection target that has been designated beforehand and the required depth distance (for example, 100 m). The required depth distance corresponds to the braking distance of the subject vehicle 101 that changes depending on the vehicle speed. In the embodiment, a value obtained by adding a predetermined margin to the braking distance is referred to as the required depth distance on the basis of the idea that the road surface situation of the road in the traveling direction of the traveling subject vehicle 101 is to be detected at least beyond the braking distance. The vehicle speed of the subject vehicle 101 is detected by the vehicle speed sensor of the internal sensor group 3. The relationship between the vehicle speed and the required depth distance is stored in advance in the storage unit 12. Reference sign N in FIG. 5A indicates the required depth distance when the vehicle speed is, for example, 100 km/h.

As an example of the angular resolution in a case where a detection target of 15 cm is detected at 100 m as the required depth distance, 0.05 deg is required in each of the vertical direction and the horizontal direction as described below with reference to FIG. 5B. Note that in a case where a detection target having a smaller size than 15 cm is detected, and in a case where a detection target of 15 cm is detected at the depth distance X longer than 100 m, it is necessary to further increase the number of irradiation points in the FOV by increasing the angular resolution.

For example, the external environment recognition device 50 calculates the positions of the irradiation points so as to be arranged in a lattice pattern in the FOV, and causes the intervals of the lattice points in the vertical direction and the horizontal direction to correspond to the angular resolutions in the vertical direction and the horizontal direction, respectively. In a case of increasing the angular resolution in the vertical direction, the FOV is divided in the vertical direction by the number based on the angular resolution, and the lattice interval in the vertical direction is narrowed to increase the number of irradiation points. In other words, the interval of the irradiation points is made dense. On the other hand, in a case of reducing the angular resolution in the vertical direction, the FOV is divided in the vertical direction by the number based on the angular resolution, and the lattice interval in the vertical direction is widened to reduce the number of irradiation points. In other words, the interval of the irradiation points is made sparse. The same applies to the horizontal direction.

The external environment recognition device 50 generates information (hereinafter, referred to as irradiation point information) indicating the position of the irradiation point that has been calculated in accordance with the angular resolution, and stores the information in the storage unit 12 in association with the position information indicating the current traveling position of the subject vehicle 101.

### <Angular Resolution and Depth Distance>

FIG. 5B is a schematic diagram illustrating an example of the relationship between the depth distance X and the angular resolution in the vertical direction, and illustrates the angular resolution (also referred to as required angular resolution) required for recognizing the detection target having the above-described size (15 cm both vertically and horizontally). The horizontal axis indicates the depth distance X (unit: m), and the vertical axis indicates the angular resolution (unit: deg) in the vertical direction. In general, since the viewing angle with respect to the detection target increases as the depth distance X decreases (in other words, the detection target is close to the subject vehicle 101), it is possible to detect the detection target even when the angular resolution is low. On the other hand, since the viewing angle with respect to the detection target decreases as the depth distance X increases (in other words, the detection target is far from the subject vehicle 101), high angular resolution is required for detecting the detection target. Therefore, as illustrated in FIG. 5B, the external environment recognition device 50 decreases the angular resolution (increases the value of the angular resolution) as the depth distance X is shorter, and increases the angular resolution (decreases the value of the angular resolution) as the depth distance X is longer.

Note that, although not illustrated, the same applies to the relationship between the depth distance X and the angular resolution in the horizontal direction.

Reference sign N in FIG. 5B indicates the required depth distance when the vehicle speed is, for example, 100 km/h.

When the subject vehicle 101 travels in the self-drive mode, the external environment recognition device 50 sets a predetermined irradiation point (detection point) in the FOV and controls the LiDAR 5 to emit irradiation light. Thus, the irradiation light from the LiDAR 5 is emitted toward the irradiation point (detection point) that has been set.

Note that the irradiation light of the LiDAR 5 may be emitted in a raster scanning method to all irradiation points (detection points) arranged in a lattice pattern in the FOV, or the irradiation light may be intermittently emitted so that the irradiation light is emitted only on a predetermined irradiation point (detection point), or may be emitted in any other mode.

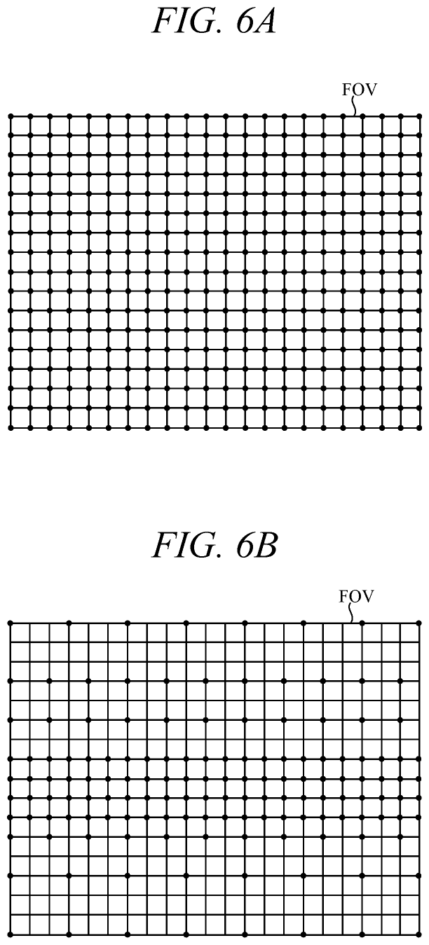

FIG. 6A is a schematic diagram illustrating an example of an irradiation point when the irradiation light of the LiDAR 5 is emitted in a raster scanning method. When emitting the irradiation light from the LiDAR 5, the external environment recognition device 50 sets the angular resolution required at the required depth distance N for the entire area in the FOV and controls the irradiation direction of the irradiation light.

For example, when the required angular resolution for recognizing the detection target present at the location point of the required depth distance N on the road RD is 0.05 deg both vertically (vertical direction) and horizontally (horizontal direction), the external environment recognition device 50 performs control to shift the irradiation direction of the irradiation light at an interval of 0.05 deg vertically and horizontally in the entire area of the FOV. That is, in FIG. 6A, each black circle of the grid point corresponds to the irradiation point (detection point), and the vertical and horizontal intervals of irradiation points (detection points) correspond to the angular resolution of 0.05 deg.

The number of actual irradiation points within the FOV is much greater than the number of black circles illustrated in FIG. 6A. As a specific example, when the FOV of the LiDAR 5 is 120 deg in the horizontal direction, 2400 black circles corresponding to the irradiation points (detection points) are arranged at an interval of 0.05 deg in the horizontal direction. Similarly, when the FOV is 40 deg in the vertical direction, 800 black circles corresponding to the irradiation points (detection points) are arranged at an interval of 0.05 deg in the vertical direction.

The external environment recognition device 50 acquires detection data of the detection points corresponding to the irradiation points in FIG. 6A each time the irradiation light for one frame is scanned with respect to the FOV, and extracts data of the detection points based on the angular resolution required for the recognition of the detection target from the detection data. More specifically, for an area of the FOV in which the depth distance X is shorter than the required depth distance N and the required angular resolution is not 0.05 deg but 0.1 deg suffices, data is extracted so that the vertical and horizontal data intervals are wider than the interval of 0.05 deg. In addition, since there is no road RD in an area of the FOV corresponding to the sky, data is extracted so as to widen the vertical and horizontal data intervals. The interval of the detection points thus extracted is similar to the interval of the detection points indicated by black circles in FIG. 6B described below.

The external environment recognition device 50 extracts the data of the detection points, so that it is possible to suppress the total number of pieces of detection data used for the recognition processing.

FIG. 6B is a schematic diagram illustrating an example of irradiation points in a case where the irradiation light of the LiDAR 5 is emitted only to predetermined irradiation points (detection points) arranged in a lattice pattern in the FOV. When emitting the irradiation light from the LiDAR 5, the external environment recognition device 50 sets an interval of irradiation points (detection points) within the FOV to an interval according to the required angular resolution and controls the irradiation direction of the irradiation light.

For example, when the required angular resolution for recognizing the detection target present at the location point of the required depth distance N on the road RD is 0.05 deg both vertically (vertical direction) and horizontally (horizontal direction), the external environment recognition device 50 performs control to shift the irradiation direction of the irradiation light at an interval of 0.05 deg vertically and horizontally in the area corresponding to the required depth distance N (band-shaped area long in the left-right direction).

In addition, for an area of the FOV in which the depth distance X is shorter than the required depth distance N and the required angular resolution of 0.1 deg suffices, the irradiation direction of the irradiation light is controlled so as to widen the vertical and horizontal intervals of the detection points. Further, since there is no road RD in an area of the FOV corresponding to the sky, the irradiation direction of the irradiation light is controlled so as to widen the vertical and horizontal intervals of the detection points.

The external environment recognition device 50 controls the interval of the detection points, so that it is possible to suppress the total number of pieces of detection data used for the recognition processing.

Note that the number of actual irradiation points within the FOV is much greater than the number of black circles illustrated in FIG. 6B.

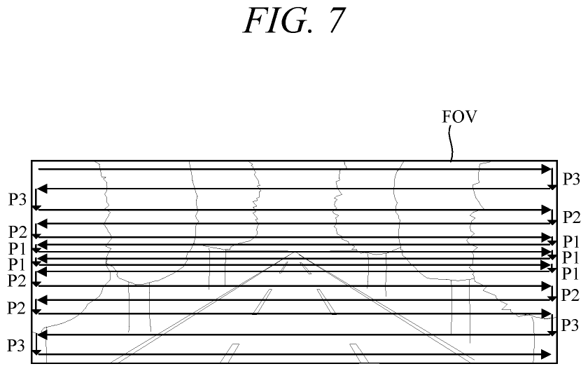

FIG. 7 is a diagram illustrating an example of an irradiation order in a case where the irradiation points illustrated in FIG. 6B are irradiated with the irradiation light. In FIG. 7, the irradiation directions of the irradiation light are controlled in the directions of arrows from the upper left to the lower right irradiation points of the FOV. In addition, Characters P1 to P3 written together with the vertical arrows indicate the magnitude of the intervals of the irradiation points (detection points), and P1 indicates, for example, an interval of the irradiation points (detection points) corresponding to an angular resolution of 0.05 deg. P2 indicates, for example, an interval of the irradiation points (detection points) corresponding to an angular resolution of 0.1 deg. P3 indicates, for example, an interval of the irradiation points (detection points) corresponding to an angular resolution of 0.2 deg.

Although FIG. 7 illustrates an example in which the angular resolution is switched in three stages, the angular resolution is not limited to the three stages, and the angular resolution may be configured to be appropriately switched in two or more stages.

### <Configuration of External Environment Recognition Device>

Details of the external environment recognition device 50 will be described.

As described above, the external environment recognition device 50 includes the recognition unit 111, the setting unit 112, the determination unit 113, the prediction unit 114, and the LiDAR 5.

### <Recognition Unit>

The recognition unit 111 generates three-dimensional point cloud data using time-series detection data detected in the FOV of the LiDAR 5.

In addition, the recognition unit 111 recognizes a road structure in the traveling direction of the road RD on which the subject vehicle 101 travels, and a detection target on the road RD in the traveling direction on the basis of the detection data that has been measured by the LiDAR 5. The road structure refers to, for example, a straight road, a curved road, a branch road, an entrance and exit of a tunnel, and the like.

Further, for example, by performing luminance filtering processing or the like on data indicating a flat road surface, the recognition unit 111 senses a division line. In this case, in a case where the height of the road surface on which the luminance exceeds a predetermined threshold is substantially the same as the height of the road surface on which the luminance does not exceed the predetermined threshold, the recognition unit 111 may determine that it is a division line.

### <Recognition of Road Structure>

An example of recognition of the road structure by the recognition unit 111 will be described. The recognition unit 111 recognizes, as boundary lines RL and RB of the road RD (FIG. 1A), a curbstone, a wall, a groove, a guardrail, or a division line on the road RD on a front side, which is the traveling direction, included in the generated point cloud data and recognizes a road structure in the traveling direction indicated by the boundary lines RL and RB. As described above, the division line includes a white line (including a line of a different color), a curbstone line, a road stud, or the like, and a traveling lane of the road RD is defined by markings with these division lines. In the embodiment, the boundary lines RL and RB on the road RD defined by the above markings will be referred to as division lines.

The recognition unit 111 recognizes an area interposed between the boundary lines RL and RB as an area corresponding to the road RD. Note that the recognition method for the road RD is not limited thereto, and the road RD may be recognized by another method.

In addition, the recognition unit 111 separates the generated point cloud data into point cloud data indicating a flat road surface and point cloud data indicating a three-dimensional object or the like. For example, among three-dimensional objects or the like on the road in the traveling direction included in the point cloud data, road surface shapes such as irregularities, steps, and undulations exceeding 15 cm in size and objects exceeding 15 cm in length and width are recognized as detection targets. 15 cm is an example of the size of the detection target, and may be appropriately changed.

### <Setting Unit>

The setting unit 112 sets the vertical light projection angle φ of the irradiation light to the LiDAR 5. When the FOV of the LiDAR 5 is 40 deg in the vertical direction, the vertical light projection angle φ is set in a range of 0 to 40 deg at an interval of 0.05 deg. Similarly, the setting unit 112 sets the horizontal light projection angle θ of the irradiation light to the LiDAR 5. When the FOV of the LiDAR 5 is 120 deg in the horizontal direction, the horizontal light projection angle θ is set in a range of 0 to 120 deg at an interval of 0.05 deg.

The setting unit 112 sets the number of irradiation points (corresponding to the number of black circles in FIGS. 6A and 6B and indicating the irradiation point density) in the FOV to the LiDAR 5 on the basis of the angular resolution determined by the determination unit 113 as described below. As described above, the intervals in the vertical direction and the horizontal direction of the irradiation points (detection points) arranged in a lattice pattern in the FOV are caused to correspond to the angular resolutions in the vertical direction and the horizontal direction, respectively.

### <Determination Unit>

The determination unit 113 determines a scanning angular resolution set by the setting unit 112. First, the determination unit 113 calculates the light projection angle α in the vertical direction at each depth distance X and the distance DL to the road surface point at each depth distance X. Specifically, as described with reference to FIG. 3D, the depth distance X is calculated on the basis of the distance DL to the road surface point measured by the LiDAR 5 and the light projection angle α set in the LiDAR 5 at the time of measurement. The determination unit 113 calculates a relationship between the calculated depth distance X and the vertical direction angle (FIG. 5A). In addition, the determination unit 113 calculates a relationship between the depth distance X and the distance DL. Further, in addition, as illustrated in FIG. 5B, the determination unit 113 calculates a relationship between the depth distance X and the vertical direction angular resolution on the basis of the size of the detection target and the depth distance X. In this manner, the vertical direction angular resolution is calculated on the basis of the size of the detection target and the distance DL, and the relationship between the depth distance X and the vertical direction angular resolution is calculated on the basis of the distance DL and the depth distance X.

Next, the determination unit 113 determines the angular resolution in the vertical direction required for recognizing the detection target of the above-described size. For example, for the depth distance X at which the angular resolution in the vertical direction is less than 0.1 deg in FIG. 5B, 0.05 deg smaller than 0.1 deg is determined as the required angular resolution. In addition, for the depth distance X at which the angular resolution in the vertical direction is 0.1 deg or more and less than 0.2 deg, 0.1 deg smaller than 0.2 deg is determined as the required angular resolution. Similarly, for the depth distance X at which the angular resolution in the vertical direction is 0.2 deg or more and less than 0.3 deg and the depth distance X at which the angular resolution in the vertical direction is 0.3 deg or more and less than 0.4 deg, 0.2 deg and 0.3 deg, which are smaller, are determined as the required angular resolution, respectively. R1, R2 and R3 correspond to P1, P2 and P3 in FIG. 7 to be described below, respectively.

The determined required angular resolution in the vertical direction can be reflected as an interval in the vertical direction of the detection points when the three-dimensional point cloud data of a next frame is acquired.

In addition, the determination unit 113 may determine the required angular resolution in the horizontal direction for recognizing the detection target according to the size of the detection target and the depth distance X. The required angular resolution in the horizontal direction can also be reflected as an interval in the horizontal direction of the detection points when the three-dimensional point cloud data of a next frame is acquired.

Note that the required angular resolution in the horizontal direction may be matched with the required angular resolution in the vertical direction determined previously. In other words, on the same horizontal line as the detection point at which the required angular resolution in the vertical direction is determined to be 0.05 deg, the required angular resolution in the horizontal direction is determined to be 0.05 deg. Similarly, on the same horizontal line as the detection point at which the required angular resolution in the vertical direction is determined to be 0.1 deg, the required angular resolution in the horizontal direction is determined to be 0.1 deg. Further, for other required angular resolutions, on the same horizontal line as the detection point at which the required angular resolution in the vertical direction is determined, the required angular resolution in the horizontal direction is determined to be the same value as the required angular resolution in the vertical direction.

### <Prediction Unit>

In a case where the traveling direction of the road RD on which the subject vehicle 101 travels is a downhill and the reflection angle from the road surface is small, or in a situation where the vehicle speed is fast and the required depth distance N increases, the LiDAR 5 may not be able to receive the scattered light up to the required depth distance N. In this case, the farthest depth distance X that can be detected by the LiDAR 5 is referred to as a maximum depth distance L. The maximum depth distance may be referred to as a maximum road surface detection distance.

When the required depth distance N calculated from the vehicle speed of the subject vehicle 101 exceeds the maximum depth distance L (for example, when the required depth distance N is 108 m, the maximum depth distance L=92 m), the prediction unit 114 predicts the height Z (gradient) of the road surface from the maximum depth distance L to the required depth distance N using the measurement data of the height Z (gradient) of the road surface from the lower end of the FOV (first predetermined distance) to the maximum depth distance L practically acquired on the basis of the detection data of the LiDAR 5. For the prediction of the gradient, for example, an AR model or an ARIMA model that is a time series prediction method can be used.

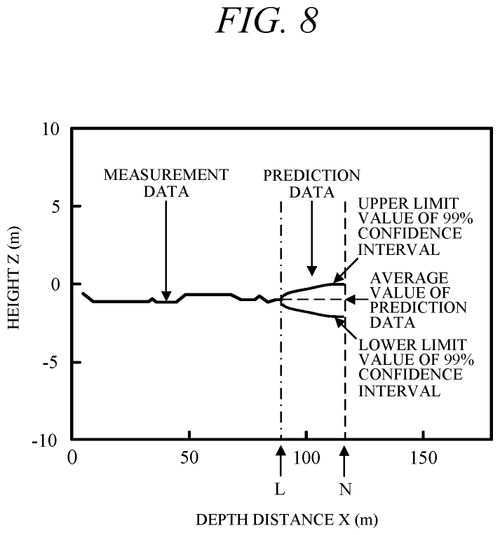

FIG. 8 illustrates an example of a result of prediction using an ARIMA model. The horizontal axis indicates the depth distance X (unit: m), and the vertical axis indicates the height Z (unit: m) of the road surface. As the prediction result, an average value of the predicted height Z, upper and lower limit values (for example, upper and lower limit values of a 99% confidence interval) of the predicted height Z, and the like are obtained. In the embodiment, a prediction value corresponding to the curve of the upper limit value of 99% confidence interval in the direction in which the area of high angular resolution in the vertical direction is further expanded is adopted as the “upper limit value of the predicted height”. With this configuration, in a case where the road RD in the FOV is an uphill, by setting the angular resolution in the vertical direction to be high in the area on the upper side in the vertical direction, it is possible to reduce the possibility of missing data when acquiring the three-dimensional point cloud data of a next frame. On the other hand, in a case where the road RD is a downhill, since the road surface is not irradiated with the irradiation light from the LiDAR 5 in the first place, the area may not be expanded to the lower side in the vertical direction. Therefore, in order to avoid unnecessary processing, the prediction value corresponding to the curve of the lower limit value of 99% confidence interval is not adopted.

As described above, the prediction unit 114 predicts the data of the road surface gradient from the maximum depth distance L to the required depth distance N using the “upper limit value of the predicted height” by an ARIMA model or the like.

Note that, in the embodiment, the measurement data practically acquired by the LiDAR 5 is used for the data of the road surface gradient on the subject vehicle 101 side with respect to the maximum depth distance L, but the average value of the height Z predicted using an ARIMA model or the like may be used instead of the measurement data by the LiDAR 5. When the average value of the height Z is used, the effect of the flattening processing can be obtained.

### <Generation of Position Data>

The external environment recognition device 50 can map data indicating the position of the detection target detected on the basis of the time-series point cloud data measured in real time by the LiDAR 5 on, for example, an X-Y two-dimensional map and generate continuous position data. In the X-Y space, information indicating the height Z is omitted, and information of the depth distance X and the horizontal distance Y remains.

The recognition unit 111 acquires the position information of a three-dimensional object or the like on the two-dimensional map stored in the storage unit 12, and performs calculation through coordinate conversion of a relative position of the three-dimensional object or the like about the position of the subject vehicle 101 from the moving speed and the moving direction (for example, an azimuth angle) of the subject vehicle 101. Every time the point cloud data is acquired by the LiDAR 5 by measurement, the recognition unit 111 performs the coordinate conversion of the relative position of the three-dimensional object or the like based on the acquired point cloud data about the position of the subject vehicle 101, and records the position on the two-dimensional map.

### <Description of Flowchart>

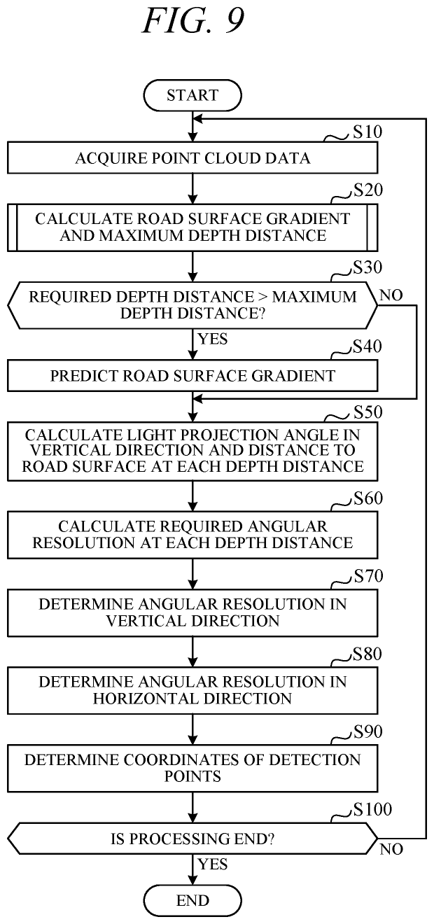

FIG. 9 is a flowchart illustrating an example of processing executed by the processing unit 11 of the controller 10 in FIG. 2 in accordance with a predetermined program. The processing illustrated in the flowchart of FIG. 9 is repeated, for example, every predetermined cycle while the subject vehicle 101 is traveling in the self-drive mode.

First, in step S10, the processing unit 11 causes the LiDAR 5 to acquire three-dimensional point cloud data, and proceeds to step S20.

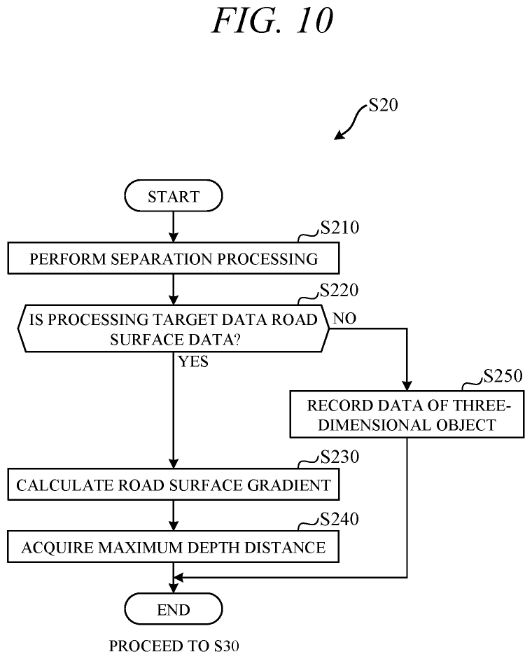

In step S20, the processing unit 11 calculates the road surface gradient in the traveling direction of the road RD and the maximum depth distance L on the basis of the point cloud data acquired by the LiDAR 5, and proceeds to step S30. Details of the processing in step S20 will be described below with reference to FIG. 10.

In step S30, the prediction unit 114 of the processing unit 11 determines whether or not the maximum depth distance Lis shorter than the required depth distance N. When the maximum depth distance L is shorter than the required depth distance N, the processing unit 11 makes an affirmative determination in step S30 and proceeds to step S40, and when the maximum depth distance L is longer than the required depth distance N, the processing unit 11 makes a negative determination in step S30 and proceeds to step S50.

In step S40, the prediction unit 114 of the processing unit 11 predicts the road surface gradient from the maximum depth distance L to the required depth distance N, and proceeds to step S50. An example of the prediction result of the road surface gradient is as illustrated in FIG. 8.

In step S50, the processing unit 11 calculates the light projection angle α in the vertical direction and the distance DL to the road surface point at each depth distance X, and proceeds to step S60. The relationship between the vertical direction angle and the depth distance X is as illustrated in FIG. 5A. In addition, the relationship between the depth distance X, the height Z of the road surface, and the distance DL to the road surface is as illustrated in FIG. 4B.

In step S60, the processing unit 11 calculates the required angular resolution at each depth distance X, and proceeds to step S70. The required angular resolution is an angular resolution required for detecting a detection target having a size designated in advance. The relationship between the depth distance X and the angular resolution is as illustrated in FIG. 5B.

In step S70, the processing unit 11 causes the determination unit 113 to determine the angular resolution in the vertical direction as the required angular resolution, and proceeds to step S80. In the embodiment, the angular resolution in the vertical direction is determined prior to the angular resolution in the horizontal direction.

In step S80, the determination unit 113 of the processing unit 11 determines the angular resolution in the horizontal direction as the required angular resolution, and proceeds to step S90. By determining the angular resolution in the horizontal direction after the angular resolution in the vertical direction, it is easy to make the angular resolution in the horizontal direction match the angular resolution in the vertical direction.

In step S90, the processing unit 11 determines the coordinates of the detection points. More specifically, coordinates indicating the positions of the detection points as exemplified by the black circles in FIG. 6B are determined. The recognition unit 111 recognizes a three-dimensional object or the like in the traveling direction of the road RD on which the subject vehicle 101 travels on the basis of the detection data detected at the positions of the detection points determined in step S90.

Note that, every time the point cloud data is acquired in step S10, the processing unit 11 maps the relative position of the three-dimensional object or the like based on the point cloud data on the X-Y two-dimensional map, thereby generating position data that is continuous in a two-dimensional manner. Then, the relative position of the three-dimensional object or the like based on the point cloud data can be coordinate-converted about the position of the subject vehicle 101 and recorded on the two-dimensional map.

In step S100, the processing unit 11 determines whether to end the processing. In a case where the subject vehicle 101 is continuously traveling in the self-drive mode, the processing unit 11 makes a negative determination in step S100, returns to step S10, and repeats the above-described processing. By returning to step S10, the measurement of the three-dimensional object or the like based on the point cloud data is periodically and repeatedly performed while the subject vehicle 101 is traveling. On the other hand, in a case where the subject vehicle 101 has finished traveling in the self-drive mode, the processing unit 11 makes an affirmative determination in step S100, and ends the processing of FIG. 9.

FIG. 10 is a flowchart for describing details of the processing of step S20 (FIG. 9) executed by the processing unit 11. The processing unit 11 performs processing according to FIG. 10 on the point cloud data of the detection points determined by the determination unit 113.

In step S210, the processing unit 11 performs separation processing on the point cloud data, and proceeds to step S220. More specifically, data of the three-dimensional object or the like on the road RD is detected and separated from the point cloud data, and point cloud data indicating a flat road surface and point cloud data indicating the three-dimensional object or the like are obtained. The three-dimensional object or the like includes, for example, an obstacle on a road, a curbstone, a wall, a groove, a guardrail, and the like provided at the left and right ends of the road RD, and in addition, other vehicles such as a motorcycle that is traveling.

An example of the separation processing will be described. The processing unit 11 coordinate-converts the relative position of the point cloud data into a position centered on the position of the subject vehicle 101, indicates the road RD on the X-Y two-dimensional map corresponding to the depth direction and the road width direction, for example, as viewed from above, and forms the two-dimensional map into grids having a predetermined size. In a case where the difference between the maximum value and the minimum value of the data in the grid in each grid is smaller than a predetermined threshold, the processing unit 11 determines that the data of the grid indicates a flat road surface. On the other hand, in a case where the difference between the maximum value and the minimum value of the data in the grid is larger than the predetermined threshold, the processing unit 11 determines that the data of the grid indicates a three-dimensional object or the like.

Note that as a method of determining whether the point cloud data corresponds to the data of the road surface or the three-dimensional object or the like, another method may be used.

In step S220, the processing unit 11 determines whether processing target data is the data of the road surface. When the data is the data of the grid separated as the data of the road surface, the processing unit 11 makes an affirmative determination in step S220 and proceeds to step S230. On the other hand, when the data is the data of the grid separated as the data of the three-dimensional object or the like, the processing unit 11 makes a negative determination in step S220 and proceeds to step S250.

In the case of proceeding to step S250, the recognition unit 111 of the processing unit 11 performs the coordinate conversion of the relative position of the three-dimensional object or the like based on the point cloud data of the grid about the position of the subject vehicle 101, and records the position on the two-dimensional map. Then, the processing in FIG. 10 ends, and the processing proceeds to step S30 in FIG. 9.

In the case of proceeding to step S230, the prediction unit 114 of the processing unit 11 calculates the road surface gradient of the road RD. An example of the road surface gradient calculation processing is as described with reference to FIGS. 3A to 3D.

Note that as the road surface gradient calculation method, another method may be used.

In step S240, the prediction unit 114 of the processing unit 11 acquires the maximum depth distance L, ends the processing in FIG. 10, and proceeds to step S30 in FIG. 9.

As described above, the maximum depth distance Lis the farthest depth distance that can be detected by the LiDAR 5. The prediction unit 114 of the processing unit 11 acquires, as the maximum depth distance L, the depth distance corresponding to the data of the grid farthest from the position of the subject vehicle 101 among the grids extracted at the time of the road surface gradient calculation processing.

According to the embodiment described above, the following operations and effects are obtained.

(1) The external environment recognition device 50 includes the LiDAR 5 as an in-vehicle detector that scans and emits irradiation light as an electromagnetic wave in the horizontal direction as a first direction and in the vertical direction as a second direction intersecting the first direction to detect the external environment situation in the periphery of the subject vehicle 101, and the processing unit 11 as a road surface information acquisition unit that acquires road surface information of the road RD on which the subject vehicle 101 travels on the basis of detection data of the LiDAR 5. The LiDAR 5 acquires three-dimensional point cloud data including distance information for each of a plurality of detection points in a matrix form frame by frame, and the processing unit 11 includes the recognition unit 111 that recognizes a road surface of the road RD and a three-dimensional object on the road for each frame as road surface information on the basis of the three-dimensional point cloud data, and the determination unit 113 that determines an interval of detection points of three-dimensional point cloud data of a next frame used for recognition by the recognition unit 111 as scanning angular resolution of irradiation light on the basis of a size of a predetermined three-dimensional object determined in advance as a recognition target and a distance from the subject vehicle 101 to the three-dimensional object.

In general, since the viewing angle with respect to the detection target increases as the depth distance X decreases, it is possible to detect the detection target even when the angular resolution is low. On the other hand, since the viewing angle with respect to the detection target decreases as the depth distance X increases, high angular resolution is required for detecting the detection target. In the embodiment, the LiDAR 5 acquires the depth distance X to the road surface of the road RD in the traveling direction for each detection point, and the determination unit 113 determines the scanning angular resolution of the irradiation light corresponding to the interval of the detection points required for the recognition unit 111 to recognize the three-dimensional object at the depth distance X.

With this configuration, the interval of the detection points of the three-dimensional point cloud data used for the recognition processing by the recognition unit 111 is appropriately controlled by the scanning angular resolution determined by the determination unit 113, so that the total number of pieces of detection data used for the recognition processing can be suppressed. That is, it is possible to reduce the processing load of the processing unit 11 without deteriorating the recognition accuracy of the position and size of the object or the like to be a detection target of the external environment recognition device 50.

In addition, in the embodiment, even in a case where the subject vehicle 101 travels on the road RD that is not included in the high-precision map information, the road RD to travel for the first time in a state in which the high-precision map information is not included, and the road RD that changes to a mode different from the high-precision map information due to construction or the like, it is possible to determine the scanning angular resolution of the irradiation light corresponding to the interval of the detection points required for the recognition unit 111 to recognize the three-dimensional object at each depth distance X while acquiring the depth distance X to the road surface of the road RD in the traveling direction for each detection point by using the LiDAR 5.

(2) In the external environment recognition device 50 of (1), the LiDAR 5 scans and emits the irradiation light in the horizontal direction and the vertical direction to acquire the three-dimensional point cloud data including the distance information for each of the plurality of detection points arranged in the horizontal direction and the vertical direction frame by frame, and the determination unit 113 determines the scanning angular resolution in the vertical direction of the irradiation light corresponding to the interval of the detection points in the vertical direction of the three-dimensional point cloud data of a next frame used for recognition by the recognition unit 111 on the basis of the length in the vertical direction of the three-dimensional object and the distance from the subject vehicle 101 to the three-dimensional object.

With this configuration, the interval in the vertical direction of the detection points of the three-dimensional point cloud data used for the recognition processing by the recognition unit 111 is appropriately controlled by the scanning angular resolution in the vertical direction determined by the determination unit 113, so that the total number of pieces of detection data used for the recognition processing can be suppressed. That is, it is possible to reduce the processing load of the processing unit 11 without deteriorating the recognition accuracy of the position and size in the vertical direction of the object or the like to be a detection target of the external environment recognition device 50.

(3) In the external environment recognition device 50 of (2), the determination unit 113 further determines the interval of the detection points in the vertical direction of the three-dimensional point cloud data of a next frame corresponding to the road surface of the road RD and the three-dimensional object on the road at the required depth distance (hereinafter, also referred to as a required distance) N based on the vehicle speed of the subject vehicle 101 as a first scanning angular resolution (for example, an interval corresponding to 0.05 deg) in the vertical direction of the irradiation light, and determines the interval of the detection points in the vertical direction of the three-dimensional point cloud data of a next frame corresponding to the road surface of the road RD and the three-dimensional object on the road at the position where the depth distance X from the subject vehicle 101 is shorter than the required depth distance N as a second scanning angular resolution (for example, an interval corresponding to 0.1 deg) coarser than the first scanning angular resolution.

With this configuration, for example, while higher recognition accuracy is secured in an area far from the subject vehicle 101, the recognition accuracy is lowered in an area close to the subject vehicle 101 as compared with the area far from the subject vehicle 101, and the total number of pieces of detection data used for the recognition processing by the recognition unit 111 can be suppressed.

(4) In the external environment recognition device 50 of (3), the determination unit 113 further determines the interval of the detection points in the vertical direction of the three-dimensional point cloud data of a next frame corresponding to an upper side of the road surface of the road RD at the required depth distance N as a third scanning angular resolution (for example, an interval corresponding to 0.1 deg) coarser than the first scanning angular resolution (for example, an interval corresponding to 0.05 deg).

With this configuration, for example, while higher recognition accuracy is secured in an area corresponding to the required depth distance N, the recognition accuracy is lowered in an area of the sky thereabove, and the total number of pieces of detection data used for the recognition processing by the recognition unit 111 can be suppressed.

(5) In the external environment recognition device 50 of (2) to (4), the determination unit 113 determines the first scanning angular resolution, the second scanning angular resolution, or the third scanning angular resolution in the vertical direction so that the intervals of the detection points in the vertical direction of the three-dimensional point cloud data of a next frame used for recognition by the recognition unit 111 match among the plurality of detection points arranged in the horizontal direction.

With this configuration, for example, regarding the positions of the detection points arranged in a lattice pattern in the FOV, it is possible to make the intervals in the vertical direction and the horizontal direction correspond to the angular resolutions in the vertical direction and the horizontal direction, respectively.

(6) In the external environment recognition device 50 of (2), the determination unit 113 determines the scanning angular resolution in the horizontal direction of the irradiation light corresponding to the interval of the detection points in the horizontal direction of the three-dimensional point cloud data of a next frame used for recognition by the recognition unit 111 on the basis of the length in the horizontal direction of the three-dimensional object and the depth distance X from the subject vehicle 101 to the three-dimensional object.

With this configuration, the interval in the horizontal direction of the detection points of the three-dimensional point cloud data used for the recognition processing by the recognition unit 111 is appropriately controlled by the scanning angular resolution in the horizontal direction determined by the determination unit 113, so that the total number of pieces of detection data used for the recognition processing can be suppressed. That is, it is possible to reduce the processing load of the processing unit 11 without deteriorating the recognition accuracy of the position and size in the horizontal direction of the object or the like to be a detection target of the external environment recognition device 50.

(7) In the external environment recognition device 50 of (1), the processing unit 11 further includes: the prediction unit 114 that predicts the gradient of the road RD from the maximum depth distance L to the required depth distance N when the maximum depth distance L as the farthest distance of the road surface in the traveling direction of the subject vehicle 101 recognized by the recognition unit 111 is shorter than the required depth distance N based on the vehicle speed of the subject vehicle 101; and the setting unit 112 that sets the irradiation angle of the irradiation light in the vertical direction such that the road surface and the three-dimensional object on the road away from the subject vehicle 101 the required depth distance N on the road RD whose gradient is predicted by the prediction unit 114 are scanned and irradiated with the irradiation light.

With this configuration, even when it is necessary to detect an object or the like on the road up to the required depth distance N farther than the maximum depth distance L at which the gradient of the road RD can be detected, the gradient of the road RD ahead of the maximum depth distance L can be statistically predicted using the measurement data up to the maximum depth distance L practically acquired by the LiDAR 5. Therefore, it is possible to calculate the light projection angle and the angular resolution in the vertical direction over the entire area up to the required depth distance N and to detect an object or the like.

(8) In the external environment recognition device 50 of (7), the determination unit 113 further determines the interval of the detection points of the three-dimensional point cloud data of a next frame corresponding to the road surface from the maximum depth distance L to the required depth distance N on the road RD whose gradient is predicted by the prediction unit 114 and the three-dimensional object on the road as the scanning angular resolution of the irradiation light on the basis of the size of the three-dimensional object and the distance from the subject vehicle 101 to the three-dimensional object.

With this configuration, also regarding the road RD whose gradient is predicted by the prediction unit 114, the interval of the detection points of the three-dimensional point cloud data used for the recognition processing by the recognition unit 111 is appropriately controlled by the scanning angular resolution determined by the determination unit 113, so that the total number of pieces of detection data used for the recognition processing can be suppressed. That is, it is possible to reduce the processing load of the processing unit 11 without deteriorating the recognition accuracy of the position and size of the object or the like to be a detection target of the external environment recognition device 50.

The above embodiment can be modified in various modes. Hereinafter, modifications will be described.

### (First Modification)

The reflection intensity of the irradiation light by the LiDAR 5 is weak on a road surface far away from the subject vehicle 101, and reflected light with sufficient intensity may not be detected in some cases. A depth distance X in such a case where the reflection intensity on the road surface decreases to a barely detectable level also corresponds to the maximum depth distance L.

In the first modification, when the required depth distance N calculated from the vehicle speed of the subject vehicle 101 exceeds the maximum depth distance L (for example, when the required depth distance N is 150 m, the maximum depth distance L=110 m), the prediction unit 114 described above may predict the height Z (gradient) of the road surface from the maximum depth distance L to the required depth distance N using the measurement data practically acquired by the LiDAR 5 from the lower end of the FOV (first predetermined distance) to the maximum depth distance L. For the prediction of the gradient, the above-described ARIMA model or the like can be used.

According to the first modification, even in a situation in which it is difficult to detect the road surface itself depending on the state of the road surface, it becomes possible to detect irregularities of the road surface, three-dimensional objects, or the like, which have a level of reflected light higher than that of the reflected light on the road surface as appropriate when acquiring the three-dimensional point cloud data of a next frame.

### (Second Modification)

In the above-described embodiment, the example in which the external environment recognition device 50 causes the LiDAR 5 to detect the road surface situation in the traveling direction of the subject vehicle 101 has been described. Instead, for example, the configuration may be such that the LiDAR 5 having an FOV capable of 360 deg detection of the periphery of the subject vehicle 101 is provided, and the LiDAR 5 detects the road surface situation of the entire periphery of the subject vehicle 101.

The above embodiment can be combined as desired with one or more of the above modifications. The modifications can also be combined with one another.

According to the present invention, it is possible to reduce the load of processing of recognizing the external environment situation in the periphery of the vehicle. Above, while the present invention has been described with reference to the preferred embodiments thereof, it will be understood, by those skilled in the art, that various changes and modifications may be made thereto without departing from the scope of the appended claims.

What is claimed is:

1. An external environment recognition apparatus comprising:
an in-vehicle detector configured to scan and emit an electromagnetic wave in a first direction and as a second direction intersecting the first direction to detect an external environment situation around a subject vehicle;
a microprocessor configured to acquire road surface information of a road on which the subject vehicle travels based on a detection data of the in-vehicle detector; and
a memory coupled to the microprocessor, wherein
the in-vehicle detector acquires a three-dimensional point cloud data including distance information for each of a plurality of detection pointes in a matrix form frame by frame, and
the microprocessor is configured to perform:
recognizing a surface of the road and a three-dimensional object on the road for each frame as the road surface information based on the three-dimensional point cloud data, and
determining an interval of detection points of the three-dimensional point cloud data of a next frame used for recognition in the recognizing as a scanning angular resolution of the electromagnetic wave based on a size of a predetermined three-dimensional object determined in advance as a recognition target and a distance from the subject vehicle to the predetermined three-dimensional object.

2. The external environment recognition apparatus according to claim 1, wherein
the microprocessor is configured to further perform
setting an interval of irradiation points in a horizontal direction and a vertical direction according to the scanning angular resolution of the electromagnetic wave determined in the determining.

3. The external environment recognition apparatus according to claim 1, wherein
the in-vehicle detector scans and emits the electromagnetic wave in a horizontal direction as the first direction and a vertical direction as the second direction to acquire the three-dimensional point cloud data including the distance information for each of the plurality of detection points arranged in the horizontal direction and the vertical direction frame by frame, and
the microprocessor is configured to perform
the determining including determining the scanning angular resolution in the vertical direction of the electromagnetic wave corresponding to the interval of the detection points in the vertical direction of the three-dimensional point cloud data of a next frame used for the recognition in the recognizing based on a length in the vertical direction of the predetermined three-dimensional object and the distance from the subject vehicle to the predetermined three-dimensional object.

4. The external environment recognition apparatus according to claim 3, wherein
the microprocessor is configured to perform
the determining including further determining an interval of the detection points in the vertical direction of the three-dimensional point cloud data of the next frame corresponding to the surface of the road and the predetermined three-dimensional object on the road at a required distance based on a vehicle speed of the subject vehicle as a first scanning angular resolution and determining an interval of the detection points in the vertical direction of the three-dimensional point cloud data of the next frame corresponding to the surface of the road and the predetermined three-dimensional object on the road at a position where a distance from the subject vehicle is shorter than the required distance as a second scanning angular resolution coarser than the first scanning angular resolution.

5. The external environment recognition apparatus according to claim 4, wherein
the microprocessor is configured to perform
the determining including further determining an interval of the detection points in the vertical direction of the three-dimensional point cloud data of the next frame corresponding to an upper side of the surface of the road at the required distance as a third scanning angular resolution coarser than the first scanning angular resolution.

6. The external environment recognition apparatus according to claim 3, wherein
the microprocessor is configured to perform
the determining including determining the first scanning angular resolution, the second scanning angular resolution, or the third scanning angular resolution in the vertical direction so that the interval of the detection points in the vertical direction of the three-dimensional point cloud data of the next frame used for the recognition in the recognizing match among the plurality of detection points arranged in the horizontal direction.

7. The external environment recognition apparatus according to claim 3, wherein
the microprocessor is configured to perform
the determining including determining the scanning angular resolution in the horizontal direction of the electromagnetic wave corresponding to the interval of the detection points in the horizontal direction of the three-dimensional point cloud data of the next frame used for the recognition in the recognizing based on a length in the horizontal direction of the predetermined three-dimensional object and the distance from the subject vehicle to the predetermined three-dimensional object.

8. The external environment recognition apparatus according to claim 1, wherein
the microprocessor is configured to further perform
when a farthest distance of the surface of the road in a traveling direction of the subject vehicle recognized in the recognizing is shorter than the required distance based on the vehicle speed of the subject vehicle, predicting a gradient of the road form the farthest distance to the required distance, and
setting an irradiation angle of the electromagnetic wave in the vertical direction such that the surface of and the predetermined three-dimensional object on the road which is at the required distance away from the subject vehicle and whose gradient is predicted in the predicting are scanned and irradiated with the electromagnetic wave.

9. The external environment recognition apparatus according to claim 8, wherein
the microprocessor is configured to perform
the predicting including, when the farthest distance recognized in the recognizing is shorter than the required distance, predicting a gradient of the road from the farthest distance to the required distance based on a measurement data of a gradient of the road from depth distance corresponding to a lower end of FOV of the in-vehicle detector to the farthest distance.

10. The external environment recognition apparatus according to claim 8, wherein
the microprocessor is configured to perform
the determining including further determining the interval of the detection points of the three-dimensional point cloud data of the next frame corresponding to the surface of and the predetermined three-dimensional object on the road from the farthest depth distance to the required distance whose gradient is predicted in the predicting as the scanning angular resolution of the electromagnetic wave based on a size of the predetermined three-dimensional object and the distance form the subject vehicle to the predetermined three-dimensional object.

11. The external environment recognition apparatus according to claim 1, wherein the in-vehicle detector is a LiDAR.
